(19) United States
(12) Patent Application Publication
(10) Pub. No.: US 2006/0060226 A1
(43) Pub. Date: Mar. 23, 2006

(54) Dishwasher and control method thereof

(75) Inventors: Sang Heon Yoon, Seoul (KR); Nung Seo Park, Bupyeong-gu (KR); Soung Bong Choi, Changwon-si (KR); Dae Yeong Han, Seoul (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/090,304

(22) Filed: Mar. 28, 2005

(30) Foreign Application Priority Data
Sep. 22, 2004 (KR) P2004-75851

(51) Int. Cl. B08B 3/00; B08B 3/04

(52) U.S. Cl. 134/56 D; 134/104.2

(57) ABSTRACT

The present invention provides a dishwasher and control method thereof, in which a contamination level of water is decided to prevent waste of the water and to appropriately control a washing time. The present invention includes a sump for receiving water, a washing pump for pumping the water received in the sump, a filter for filtering the water pumped by the washing pump, and a contamination level sensor for measuring a contamination level of the water, wherein the contamination level sensor is located on a sampling passage through which washing water passes in route to a drain chamber.

This application claims the benefit of the Korean Application No. P2004-75851 filed on Sep. 22, 2004, which is hereby incorporated by reference.

### BACKGROUND OF THE INVENTION

1. Field of the Invention

The present invention relates to a dishwasher, and more particularly, to a dishwasher and control method thereof by which waste of water is prevented and by which a washing time can be appropriately adjusted.

2. Discussion of the Related Art

First of all, a dishwasher according to a related art is explained with reference to the attached drawings as follows.

FIG. 1 is a cross-sectional diagram of a dishwasher according to a related art.

Referring to FIG. 1, within a tub 1 of a dishwasher provided are upper and lower spray arms 4 and 5, upper and lower racks 6 and 7, and a driving unit 10 including a sump 20, a washing motor 40, and a drain pump (shown in FIG. 2).

Upper and lower connecting pipes 2 and 3 for pumping water and a drain hose 9 for draining water are connected to the sump 20 configuring the driving unit 10. And, the upper and lower spray arms 4 and 5 are connected to the upper and lower connecting pipes 2 and 3, respectively. The upper rack 6 is provided over the upper spray arm 4, and the lower rack 7 is provided over the lower spray arm 5.

The upper and lower spray arms 4 and 6 are rotatably provided over the sump 40. Each of the spray arms 4 and 6 is provided with spray holes to spray water on the corresponding rack. And, a separate spray hole is further provided to the lower spray arm to detach garbage blocking a filter of the driving unit 10. Dotted lined in FIG. 1 display that the water is sprayed via the spray holes.

FIG. 2 is an exploded diagram of the driving unit in FIG. 1.

Referring to FIG. 2, a driving unit 10 includes a sump 20 receiving water therein, a heater 30 provided to the sump 20 to heat the water, a washing motor 40 provided to a bottom of the sump 20 to provide a drive force of pumping the water within the sump 20, an impeller 42 coupled with a shaft of the washing motor 40 to pump the water and to configure a washing pump together with the washing motor 40, a drain pump 50 connected to the sump 20 to drain the water, and a filtering means for filtering the pumped water except the water guided to spray arms.

A water receiving portion 21 is provided to the sump 20 to substantially form a space storing the water therein. And, a drain chamber 22 is provided to the sump 20 to be partitioned from the water receiving portion 21.

A passage controller 25, which is configured with a passage control motor and a passage control switch, is provided to an outside of the water receiving portion 21, and a passage control valve 26 is shaft-coupled with the passage control motor configuring the passage controller 25.

The drain pump 50 is connected to the drain chamber 22 of the sump 20. The drain pump 50 consists of a drain motor 51 and an impeller 52.

The filtering means consists of a pump housing 60 having a space for installing the impeller 42 for water pumping, a filter housing 70 covering a topside of the pump housing 60, and a cover 80 covering the filter housing 70 and a topside of the sump 20. The pump housing 60 is arranged below the filter housing 70 and the cover 80 is arranged on the filter housing 70.

A contaminant collection chamber 75 is provided to the filter housing 70, and a drainpipe 75a is provided to one side of the contaminant collection chamber 75. The drainpipe 75a is downwardly projected from a bottom of the filter housing 70 to have a predetermined length to be situated at the drain chamber 22 in assembly.

A filter 81 is provided to the cover 80 to oppose the contaminant collection chamber 75 of the filter housing 60, and a multitude of recovery holes 82 are provided to the cover 80 outside the filter 81. The recovery holes 82 are configured to communicate with the sump 20.

The filter housing 70 assembled to the passage control valve 26 is explained in detail with reference to FIG. 3 and FIG. 2 as follows.

First of all, the filter housing 70 is provided with a water inlet 72 allowing the water pumped by the impeller 42 in FIG. 2 to be introduced therein, main passages 73a and 73b connected to the water inlet 72, a sampling passage 74 connected to the water inlet 72, and the contaminant collection chamber 75 connected to the sampling passage 74. And, the contaminant collection chamber 75 is provided with an opening/closing valve allowing the water and garbage in the contaminant collection chamber 75 to be discharged.

The sampling passage 74 is a passage to keep filtering particles involved in the water gathering in the sump 20 using a portion of the water flowing from the water inlet 72.

The passage control valve 26 is rotatably loaded in the water inlet 72 of the filter housing 70 to open/close the main passages 73a and 73b. Furthermore, the passage control valve 26 is shaft-coupled with the motor of the passage controller 25 provided to the sump 20. Moreover, an opening/closing rib 26a is provided to a rim of the passage control valve 26 to control the passages.

An operation of the above-configured dishwasher is explained as follows.

First of all, the dishwasher washes dishes in a manner of executing preliminary washing, main washing, rinsing, heating rinsing, and drying cycles sequentially or selectively. Besides, a drain cycle is executed between the respective cycles. Specifically, the main washing cycle is explained in the following.

Referring to FIGS. 4 to 5D, once the main washing cycle is initiated, the washing motor 40 is driven to rotate the impeller 42. If so, the impeller 42 pumps the water (including detergent) in the sump 20 to the water inlet 72 of the pump housing 60, which is indicated by arrows in FIG. 4.

In doing so, as the passage controller 25 is rotated, the passage control valve 26 selectively opens one of the main passages 73a and 73b, as shown in FIG. 5A and FIG. 5B, or both of the main passages 73a and 73b, as shown in FIG. 5C, simultaneously by a control of a microcomputer (not shown in the drawing).

Hence, most of the water of the water inlet 72 is introduced into both of the upper and lower spray arms 4 and 6 or one of the spray arms 4 and 6 via the open one of the main passages 73a and 73b according to the control of the passage controller 25 by the microcomputer, whereas the rest of the water is introduced into the contaminant collection chamber 75 via the sampling passage 74.

The passage control valve 26 is controlled to supply the water to both of the upper and lower spray arms by sustaining an open state that both of the main passages 73a and 73b are simultaneously open. Optionally, the passage control valve 26 can be controlled to alternately open the main passages 73a and 73b as well as to sustain an open state that one of the main passages 73 and 73b is open until the washing is finished.

Meanwhile, a portion of the water is always introduced into the sampling passage 74 no matter which main passage is opened by the passage control valve 26. This is to keep performing the particle filtering function on the water.

The water introduced into the contaminant collection chamber 75 via the sampling passage 74 overflows via the filter 81 situated on the contaminant collection chamber 75. In doing so, the filter 81 filters off the particles involved in the water.

Thus, the water that was filtered in the overflowing process and the water, which fell on the cover 80 after having been sprayed via the upper and lower arms 4 and 5, are introduced into the sump 20 via the recovery holes 82 of the cover 80.

If the filtering is carried out for a short time, the water-filtering effect performed via the sampling passage may not be considerable since a quantity of water passing through the sampling passage is small. Yet, the filtering is carried out continuously for a long time during the main washing cycle, whereby the entire water is almost filtered substantially.

Meanwhile, the drain cycle is executed after completion of the washing cycle.

Once the drain cycle is initiated, the drain pump 50 is driven. In doing so, the water and garbage in the sump 20 are introduced into the drain pump 50 by a suction force of the drain pump 50. Simultaneously, the water and garbage in the contaminant collection chamber 75, as shown in FIG. 5D, are introduced into the drain pump 50 via the drainpipe 75a. The water and garbage introduced into the drain pump 50 are discharged outside via the drain hose 9.

However, the related art dishwasher has the following problems or disadvantages.

First of all, the washing cycle is performed during the predefined time only according to an algorithm inputted to the microcomputer. Hence, it is unable to correct the washing time according to the contamination level of the tableware.

Namely, the washing is unconditionally performed during the predefined time without considering the contamination level. Hence, the washing is excessively performed long even if the tableware is already cleaned. On the other hand, the washing is finished too early in case of needing a more washing time, whereby the tableware fails to be cleaned.

Secondly, after the washing time expires, the draining cycle is executed without recycling the used water that is clean. Hence, the water is wasted.

### SUMMARY OF THE INVENTION

Accordingly, the present invention is directed to a dishwasher and control method thereof that substantially obviates one or more problems due to limitations and disadvantages of the related art.

An object of the present invention is to provide a dishwasher and control method thereof, by which tableware washing can be efficiently controlled by taking a contamination level of water into consideration.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a dishwasher according to the present invention includes a sump for receiving washing water, a washing pump for pumping the water received in the sump, a filter for filtering the water pumped by the washing pump, and a contamination level sensor for measuring a contamination level of the water, wherein the contamination level sensor is located on a sampling passage through which washing water passes in route to a drain chamber.

In another aspect of the present invention, a dishwasher includes a sump for receiving water, a washing pump for pumping the water received in the sump, a drain pump for draining the water received in the sump, and a filter provided to the sump, the filter including a contaminant collection chamber for filtering the water, a sampling passage for guiding a portion of the water pumped by the washing pump to the contaminant collection chamber, and a contamination level sensor for measuring a contamination level of the water on the sampling passage.

In another aspect of the present invention, a method of controlling a dishwasher includes starting a washing pump, detecting a contamination level of water, correcting a washing time previously set in a control unit according to the detected contamination level, and operating the washing pump according to the corrected washing time.

In a further aspect of the present invention, a method of controlling a dishwasher includes starting a washing pump, detecting a contamination level of water, draining a portion of the washing water by driving a drain pump if the detected contamination level exceeds a contamination level previously set by a control unit, and adding a specified amount of new water in proportion to the drained amount to the washing water.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional diagram of a dishwasher according to a related art;

FIG. 2 is an exploded diagram of a driving unit in FIG. 1;

FIG. 3 is a layout of a cover-removed driving unit in FIG. 2;

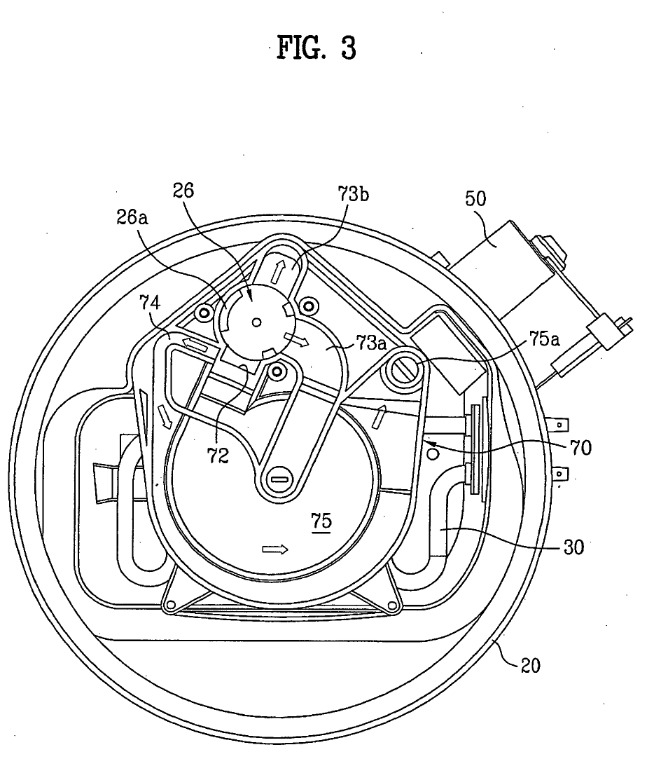

FIG. 4 is a cross-sectional diagram of a driving unit in FIG. 2, in which a flow of water is shown;

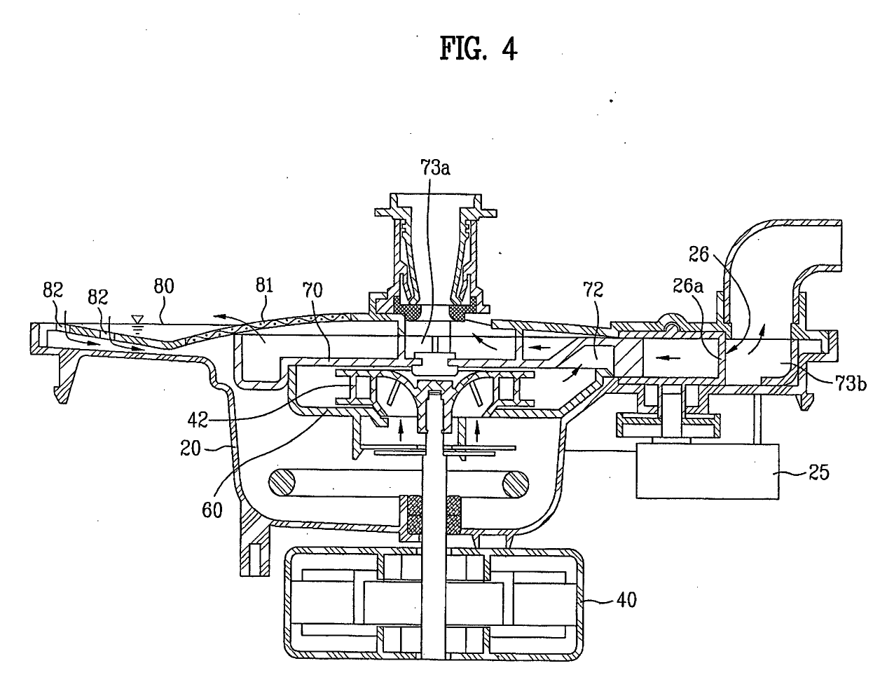

FIG. 5A is a layout for explaining a flow of water in supplying the water to a lower spray arm for a washing cycle;

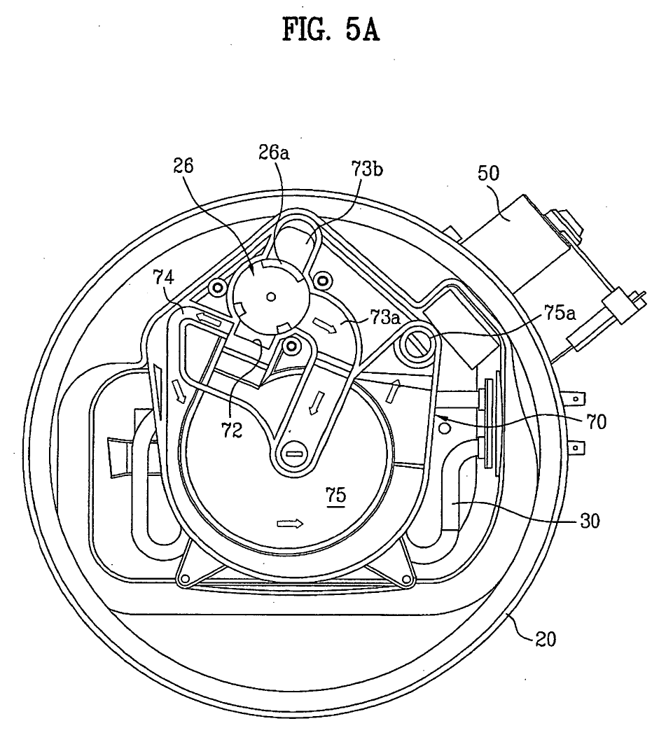

FIG. 5B is a layout for explaining a flow of water in supplying the water to an upper spray arm for a washing cycle;

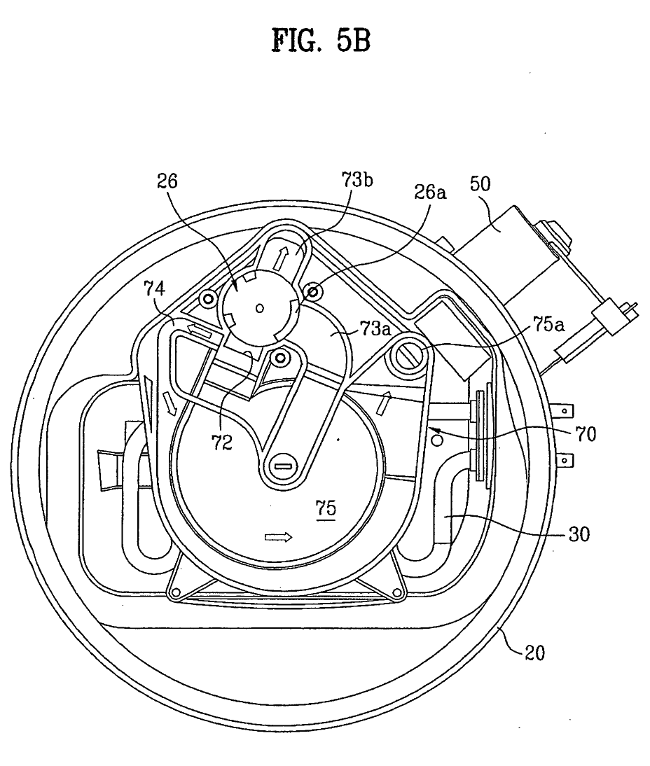

FIG. 5C is a layout for explaining a flow of water in supplying the water to both lower and upper spray arms for a washing cycle;

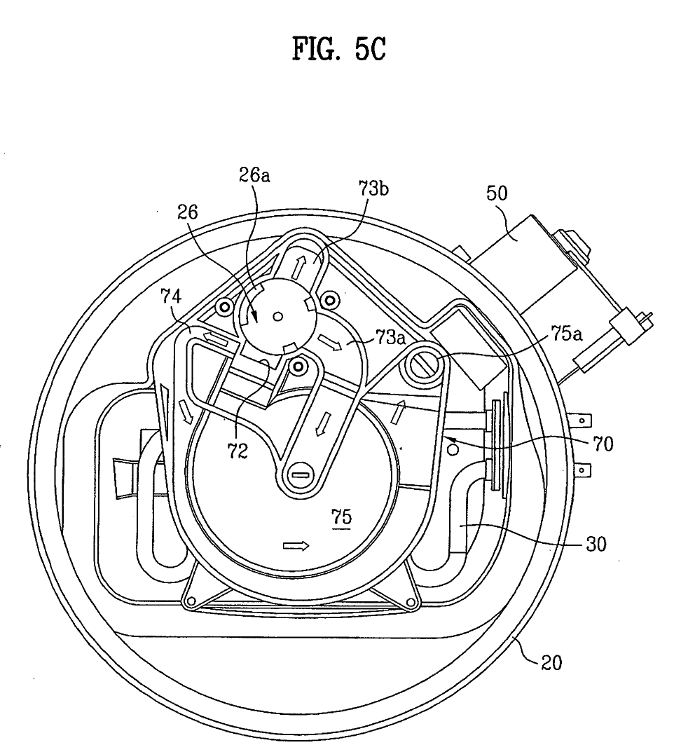

FIG. 5D is a layout for explaining a flow of water in draining the water for a draining cycle;

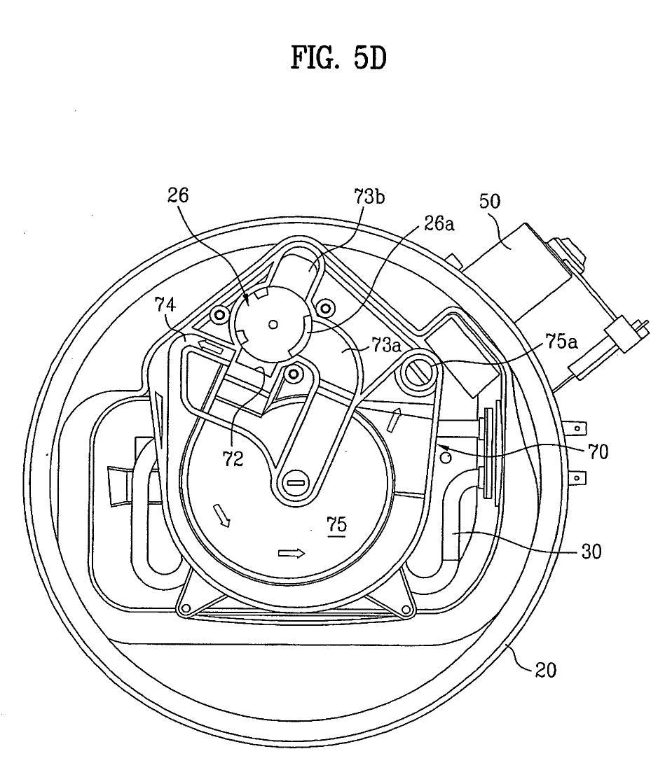

FIG. 6 is an exploded diagram of a drive unit of a dishwasher according to one embodiment of the present invention;

FIG. 7 is a perspective diagram of a filter housing assembled to a sump in FIG. 8;

FIG. 8 is a magnified perspective diagram of a portion ‘A’ in FIG. 7;

FIG. 9A is a perspective diagram for explaining a flow of water in a washing cycle;

FIG. 9B is a perspective diagram for explaining a flow of water in a draining cycle;

FIG. 10 is a flowchart of a method of controlling a driving unit of a dishwasher according to a first embodiment of the present invention; and

FIG. 11 is a flowchart of a method of controlling a driving unit of a dishwasher according to a second embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

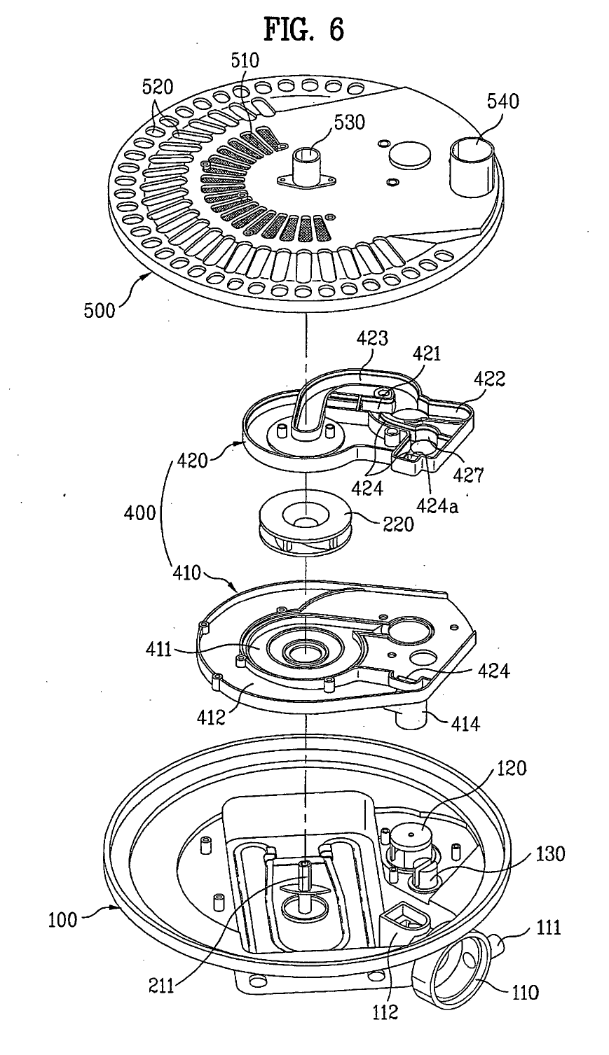

FIG. 6 is an exploded diagram of a drive unit of a dishwasher according to one embodiment of the present invention.

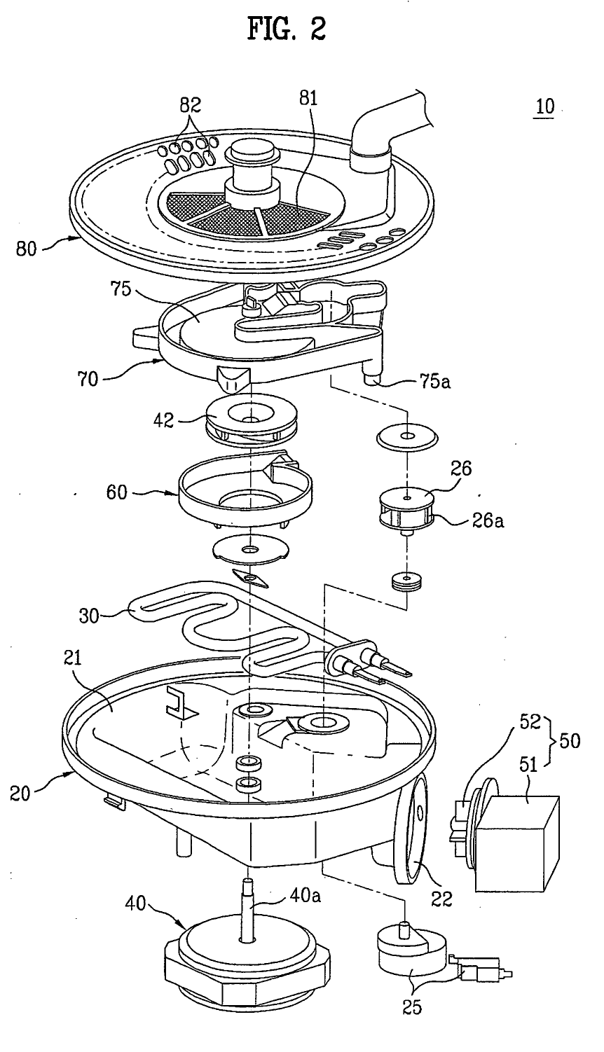

Referring to FIG. 6, a dishwasher according to one embodiment of the present invention includes a sump 100 for receiving water and having a drain chamber 110 wherein a drain pump 50 in FIG. 2 is connected to one side of the drain chamber 110, a washing pump 40 in FIG. 2 for pumping the water of the sump 100, a contaminant collection chamber 412 connected to the drain chamber 110 to be separated from the drain pump wherein the water is introduced into the contaminant collection chamber 412 via a sampling passage and the drain chamber and wherein a portion of the pumped water in washing passes through the sampling passage, and a filter for filtering contaminants contained in the water of the contaminant collection chamber 412. In this case, as the configurations of the washing and drain pumps are substantially equivalent to those in the related art, the washing and drain pumps are not shown in the drawing.

A water receiving portion 120 is provided within the sump 100, and the drain chamber 110 are provided within the sump 100 to be partitioned from the water receiving portion 120. Moreover, a drain portion 111 is provided to the drain chamber 110 to allow the water to be discharged outside during a draining cycle. Furthermore, a connecting portion 112 is provided to the drain chamber 110 to allow the water and garbage to be discharged/introduced during draining.

Meanwhile, in order to accomplish filtering, the dishwasher includes a filter housing 400 and a cover 500 covering a topside of the filter housing 400 provided with a filter portion 510 above the contaminant collection chamber 412.

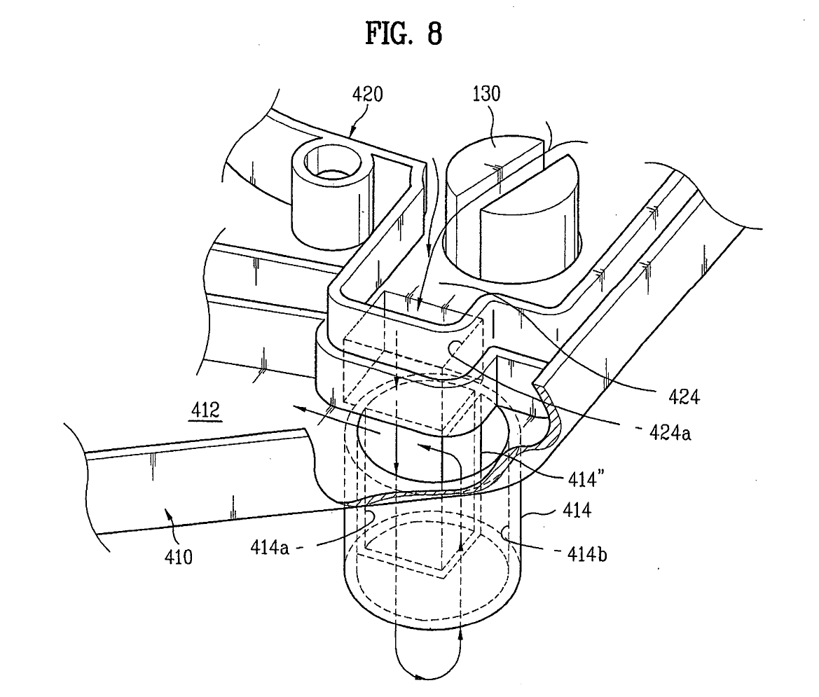

The filter housing 400 includes a lower housing 410 and an upper housing 420. The lower housing 410 is provided with an impeller seat 411, the contaminant collection chamber 412, and a passage (cf. FIG. 8) connecting the contaminant collection chamber 412 to a sampling passage 424 of the upper housing 420. Moreover, the upper housing 420 is provided with the sampling passage 424 and a contamination level sensor seat 427.

Specifically, the impeller seat 411 and the contaminant collection chamber 412 are provided to the lower housing 410. Furthermore, the contaminant collection chamber is provided to a circumference of the impeller seat 411. Moreover, the location of the impeller seat 411 can be adjusted in various ways to correspond to a location of a shaft 211 of the washing pump.

A water inlet 421 is provided to the upper housing 420 to confront an outlet of the impeller seat 411, and main passages 422 and 423 and the sampling passage 424 are respectively connected to the water inlet 421. The contamination level sensor seat 427 is provided to the sampling passage 424 to provide a contamination sensor thereon. A coupling portion 414 is provided to the lower housing 410 to confront the connecting portion 112 of the drain chamber 110. Hence, the coupling portion 414 and the connecting portion 112 are joined to each other to form a passage allowing the water in the sampling passage 424 to be introduced into the contaminant collection chamber 412 via the drain chamber 110.

A detailed explanation on the passage will be provided below.

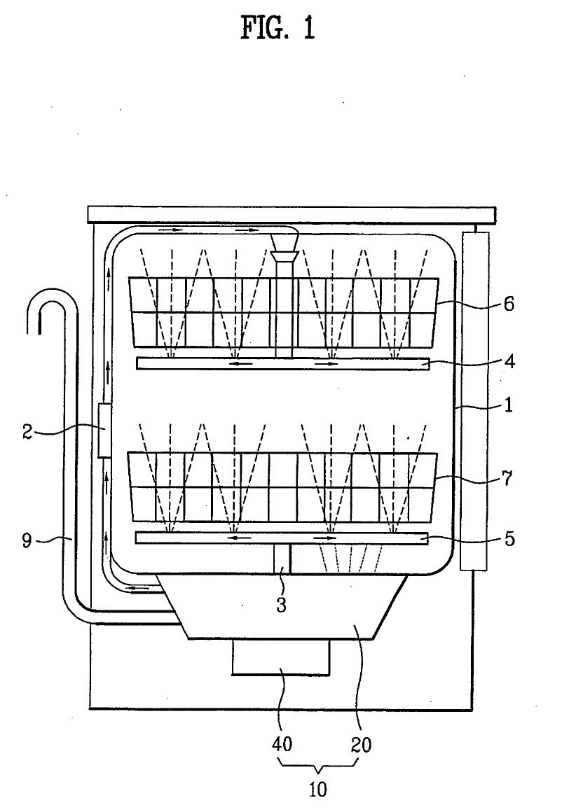

A cover 500 has a filter part 510 to cover a topside of the contaminant collection chamber 412 and a plurality of recovery holes 520 are provided to a rim of the cover 500 to communicate with the sump 100. The cover 500 includes adaptor portions 530 and 540 assembled to connecting pipes 2 and 3 in FIG. 1. Furthermore, upper and lower spray arms 4 and 5 in FIG. 1 are connected to the connecting pipes 2 and 3, respectively.

Optionally, the contaminant collection chamber 412, the sampling passage 424, and a connecting passage (not shown in the drawing) can be provided to one of the upper and lower housings 420 and 410. Also optionally, the lower and upper housings 410 and 420 can be built in one body. Alternatively, the cover 500 and the upper housing 420 can be built in one body.

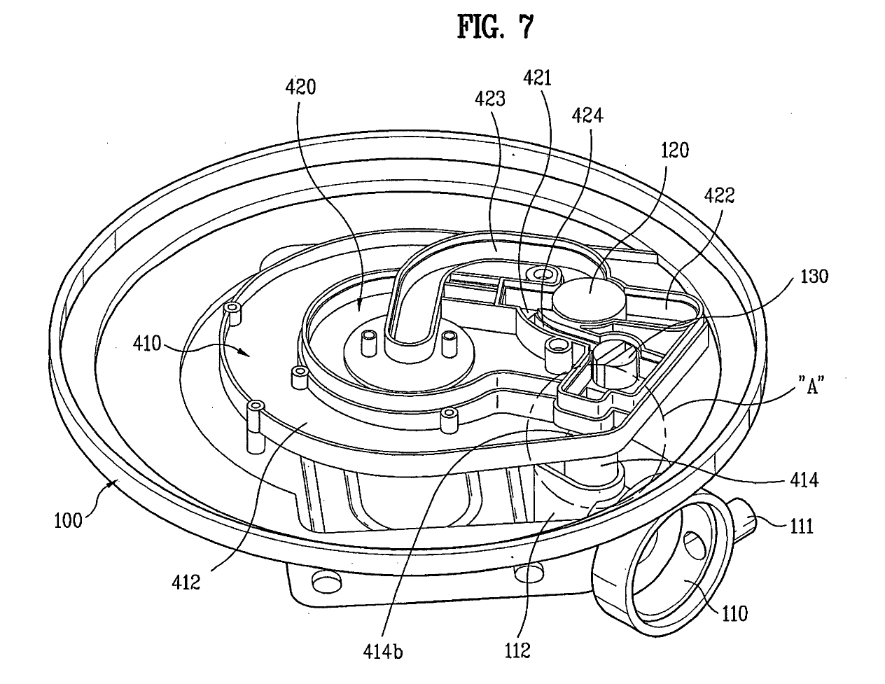

The configuration of the filter housing 400 assembled to the sump 100 is explained with reference to FIG. 6 and FIG. 7 as follows.

The filter housing 400 is assembled to the sump 100 by a plurality of bosses. The coupling portion 414 of the filter housing 400 is fitted in the connecting portion 112 of the drain chamber 110. Hence, the passage control valve 120 is provided at the water inlet 421 and the contamination level sensor 130 is provided on the sampling passage 424. Furthermore, the contamination level sensor 130 placed on the topside of the contamination level sensor seat 427. As the contamination level sensor, the present invention proposes an optical sensor for detecting turbidity of the water by using an interaction between a light-receiving unit and a light-emitting unit.

Here, the optical sensor has an exterior formed by cutting a cylinder vertically into halves and leaving a prescribed distance between the halves that are the light-receiving and light-emitting units, respectively. Hence, the exterior of the optical sensor reduces passage resistance of the water flowing along the sampling passage 424. Alternatively, the exterior of the optical sensor can be variously modified into any shape that can reduce the passage resistance such as an oval, a streamline, and the like.

Alternatively, various kinds of contamination level measurement sensors using a system different from that of the optical sensor are applicable to the embodiment of the present invention as well.

Meanwhile, the configuration of the passage connecting the sampling passage, the drain chamber, and the contaminant collection chamber is explained with reference to FIGS. 6 to 8 as follows.

A perforated hole 424a is formed at an end of the sampling passage 424 of the upper housing 420. The lower housing 410 is provided with an inner duct 414″ having a passage 414a connected to the perforated hole 424a of the upper housing 420 in assembling the upper and lower housings 420 and 410 together and an coupling portion 414 having a passage 414b communicating with the passage 414a of the inner duct 414″, the drain chamber 110, and the contaminant collection chamber 412.

Hence, at the end of the sampling passage 424, the perforated hole 424a, the passage 414a of the inner duct 414″, the passage 414b of the coupling portion 414, and the contaminant collection chamber 412 communicate with each other.

The pumped water in the sump 100 is introduced into the upper housing 420 via the water inlet 421 to flow through the sampling passage 424. The pump water is then introduced into the perforated hole 424a formed at the end of the sampling passage 424 for water to fall via the passage 414a of the inner duct 414″ of the lower housing which communicates with the perforated hole 424a. The water flowing through the passage 414a of the inner duct 414″ of the lower housing 410 is introduced into the drain chamber 110 and then flows back up or overflows via the passage 414b of the coupling portion 414. The water passed through the passage 414b is then introduced to the contaminant collection chamber 412.

If a middle part of the coupling portion is cut to examine a cross-section of the passage, an internal space of the coupling portion is partitioned by the inner duct.

An operation of the above-configured driving unit is explained as follows.

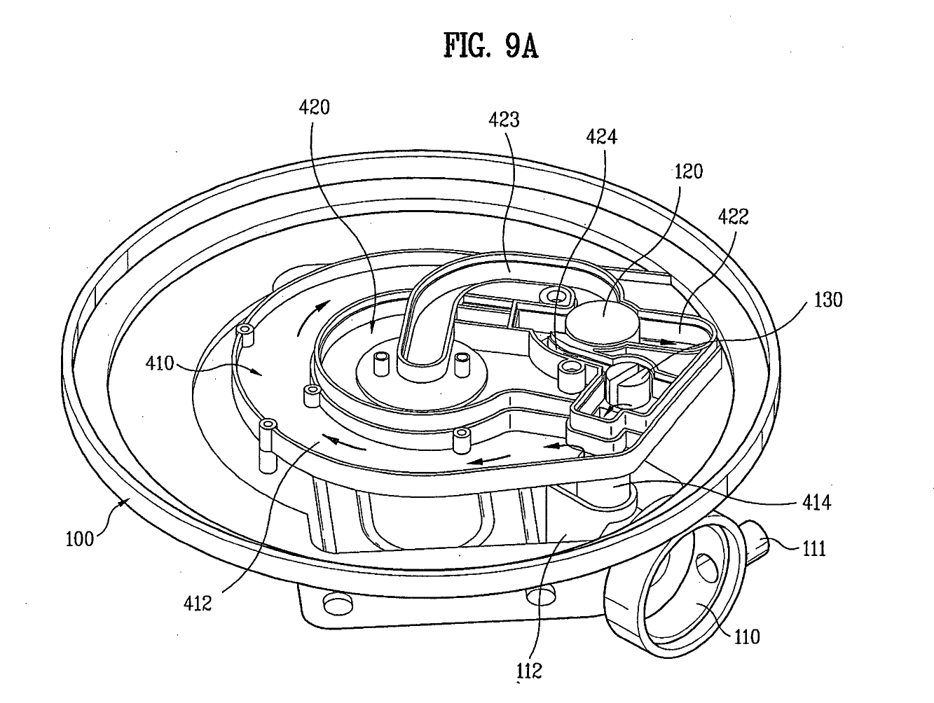

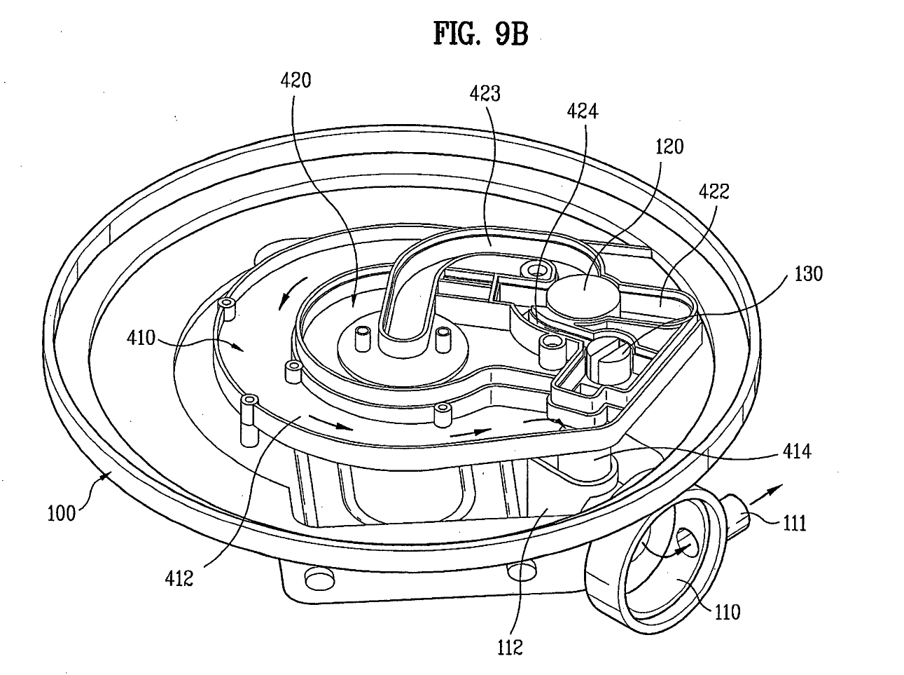

The main washing cycle is explained with reference to FIG. 9A as follows.

Once the main washing cycle is executed, the impeller 220 introduces the water of the sump 100 into the impeller seat 411, and the water is then pumped to the water inlet 421 of the filter housing 40.

For the water of the water inlet 421, the passage control valve 120 is rotated to selectively open/close the main passage 422 or 423, to simultaneously open/close the main passages 422 and 423, or to alternately open/close the main passages 422 and 423. Subsequently, a portion of the pumped water is introduced into the upper and lower spray arms via both of the main passages 422 and 423, respectively, or is introduced into the upper or lower spray arm via the main passage 422 or 423. FIG. 9A shows that the water is introduced into the upper spray arm.

The rest of the pumped water except for the water introduced into the spray arms via the main passages 422 and 423 is introduced into the sampling passage 424. As the water inlet 421 is always open, the water flows to the sampling passage 424 no matter which main passage 422 or 423 is opened by the passage control valve 120.

The water in the sampling passage 424 is introduced to the drain chamber 110 via the sampling passage 424 of the coupling portion 414. In doing so, the contamination level sensor determines the contamination level of the water and transfers the determined contamination level to the control unit.

A space provided within the drain chamber 110 is more abruptly expanded than the passage of the inner duct 414″ so that the drain chamber 110 can receive garbage and perform functions as a deposit chamber. Hence, relatively large garbage involved in the water introduced to the drain chamber 110 is deposited in the drain chamber 110 to primarily filter the garbage or the contaminants.

Subsequently, the water introduced to the drain chamber 110 ascends or overflows via the connecting passage 414b of the coupling portion 414 to flow to the contaminant collection chamber 412. In the process, the large/heavy pieces of garbage remains in the drain chamber 110 while the water having relatively small/light garbage is introduced to the contaminant collection chamber 412 due to the primary filtering of the drain chamber 110, thereby reducing inflow of the garbage.

Hence, water pressure is relatively lower than that of the related art work on the contaminant collection chamber 412 and the filter of the cover becomes less blocked.

Furthermore, the water introduced into the contaminant collection chamber 412 overflows via the filter 510. In doing so, the filter 510 of the cover 500 secondarily filters off the small garbage involved in the water. The filtered water is re-introduced into the sump 100 via the drain hole 520 of the cover 500.

Thus, the pressure enabling the water to be introduced into the contaminant collection chamber 412 via the drain chamber 110 is based on the pumping force of the impeller 220.

After completion of the washing cycle, a draining cycle is executed, which is explained with reference to FIG. 9B as follows.

First of all, once the draining cycle is initiated, the drain pump 50 in FIG. 2 is driven so that the water and garbage of the sump 100 are introduced into the drain chamber 110. Simultaneously, the other water and garbage in the contaminant collection chamber 412 are introduced into the drain chamber 110 as well. The water and garbage introduced into the drain chamber 110 are discharged outside via the drain portion 111.

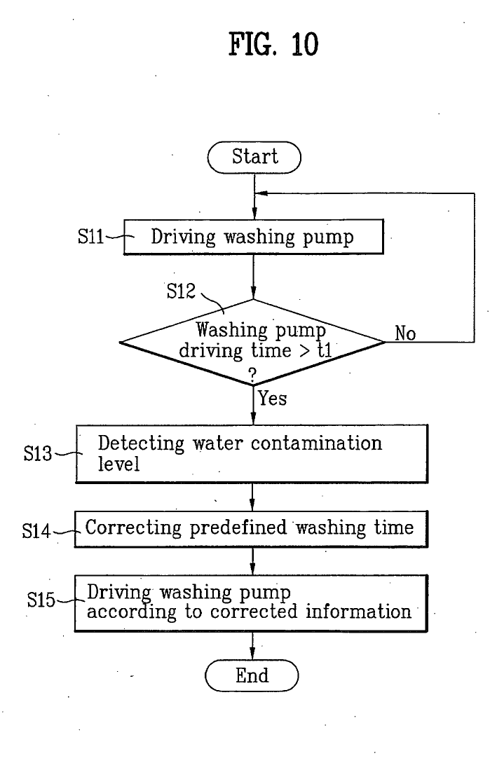

Meanwhile, a method of controlling a dishwasher according to an embodiment of the present invention is explained with reference to FIG. 10 as follows.

First of all, once a washing cycle is initiated, the washing pump is driven (S11). In the process, a portion of the pumped water is led to the spray arm(s), and the rest of the pumped water overflows from the contaminant collection chamber 412 through the filter 510 of the cover 500 for filtering of garbage in the water.

During such a process, the contamination level sensor detects the contamination level of the water (S13). Preferably, the contamination level of the water is decided after the washing pump has been driven for a predetermined time t1 (S12). This is to decide the contamination level of the water after the water has been sufficiently contaminated.

According to the detected contamination level, the predefined washing time in the control unit is corrected (S14). For instance, a weight is applied to a reference washing time previously set in the control unit according to the detected contamination level. In doing so, the reference washing time and weight are appropriately adjusted according to a volume or capacity of the dishwasher, the reference washing time, and the like.

The washing pump is driven during the corrected washing time to wash the tableware on the upper and lower racks (S15).

By the above-described control method, the washing time can be shortened by adjusting the washing time appropriately according to the contamination level of the water.

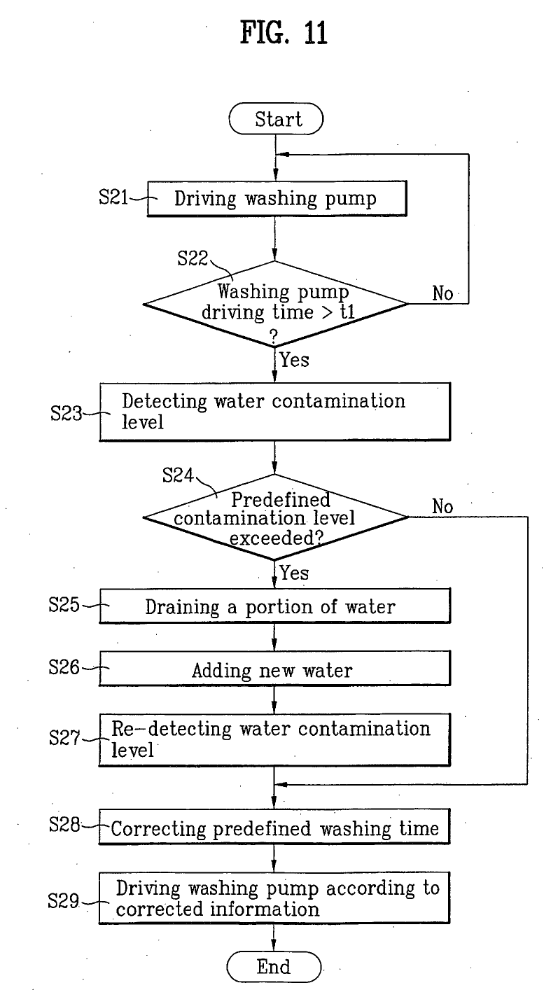

A control method according to another embodiment of the present invention is explained with reference to FIG. 11 as follows.

First of all, once a washing cycle is initiated, the washing pump is driven (S21). In doing so, a portion of the pumped water is led to the spray arm(s), and the rest of the pumped water passes through the filter 510 to be filtered in the process of overflowing over the cover 500 via the contaminant collection chamber 412.

During such a process, the contamination level sensor detects the contamination level of the water (S23). Preferably, the contamination level of the water is decided after the washing pump has been driven for a predetermined time t2 (S22).

Subsequently, a determination is made as to whether the detected contamination level exceeds a level previously set as acceptable contamination level in the control unit (S24). If the detected contamination level does not exceed the predefined level, a predefined washing time in the control unit is corrected according to the detected contamination level (S28). However, if the detected contamination level exceeds the predefined level, the drain pump is driven to drain a portion of the water in the sump (S25). In the process, it is preferable that a drain quantity of the water is adjusted according to the detected contamination level. For instance, by presetting the driving time of the drain pump according to the contamination level, it is able to appropriately adjust the drain quantity of the water. Furthermore, the predefined contamination level is preferably limited to such cases where the contamination level is high. After the portion of the water has been drained, new water in proportion to the drained quantity of the water is added (S26).

Subsequently, the contamination level sensor re-detects the contamination level of the water (S27). In doing so, the contamination level of the water is re-detected after a predetermined time from the timing point of completing addition of new water.

The washing time previously set in the control unit is then corrected according to the re-detected contamination level (S28). For instance, a weight is applied to a reference washing time previously set in the control unit according to the re-detected contamination level. In doing so, the reference washing time and weight are appropriately adjusted according to a volume or capacity of the dishwasher, the reference washing time, and the like. Thereafter, the washing pump is driven during the corrected washing time to wash the tableware on the upper and lower racks (S29).

By the above-described control method, the washing cycle can be performed using relatively less contaminated water in a manner of partially draining the highly contaminated water and re-supplying new water thereto.

Accordingly, the present invention provides the following effects or advantages.

First of all, by measuring the contamination level of the water using the contamination level sensor to determine the contaminated state of the water, the present invention appropriately adjust the washing time.

Secondly, if the water is extremely contaminated, the water is partially drained and the corresponding quantity of new water is re-supplied. Therefore, the present invention washes the tableware using relatively clean water.

Finally, if the contamination level of the water is low, the present invention reduces waste of water by recycling the water with partial addition of new water.

It will be apparent to those skilled in the art that various modifications and variations can be made in the present invention. Thus, it is intended that the present invention covers the modifications and variations of this invention provided they come within the scope of the appended claims and their equivalents.

1. A dishwasher, comprising:
a sump for receiving water;
a washing pump for pumping the water received in the sump;
a filter for filtering the water pumped by the washing pump; and
a contamination level sensor for measuring a contamination level of the water, wherein the contamination level sensor is located on a sampling passage through which washing water passes in route to a drain chamber.

2. The dishwasher of claim 1, the filter comprises:
a lower housing having a contaminant collection chamber;
an upper housing having the sampling passage; and
a cover covering a topside of the sump, the cover comprising:
a filter screen located above the contaminant collection chamber; and
a recovery hole on a periphery of the sump to receive the washing water.

3. The dishwasher of claim 2, wherein the contamination collection chamber and the sampling passage communicate through a coupling portion of the lower housing and a perforated hole formed at an end of the sampling passage of the upper housing.

4. The dishwasher of claim 3, wherein the coupling portion is connected to the perforated hole to provide a first passage for the washing water to flow, and the coupling portion is further provided with a second passage for the washing water to overflow to the contamination collection chamber.

5. The dishwasher of claim 4, wherein the first passage of the coupling portion comprises an inner duct which has a smaller circumference than that of the coupling portion to permit the washing water to overflow via the second passage which is a passage between an outer surface area of the inner duct and an inner surface area of the coupling portion.

6. The dishwasher of claim 2, wherein the coupling portion communicates with the drain chamber as well as the contaminant collection chamber.

7. The dishwasher of claim 1, wherein the contamination level sensor comprises an optical sensor having a light-receiving unit and a light-emitting unit.

8. The dishwasher of claim 7, wherein the optical sensor has an exterior formed by cutting a cylinder vertically into halves and leaving a prescribed distance between the halves that are the light-receiving and light-emitting units, respectively.

9. The dishwasher of claim 1, wherein the sampling passage receives a specified amount of washing water not provided to spray arms.

10. A dishwasher, comprising:
a sump for receiving water;
a washing pump for pumping the water received in the sump;
a drain pump for draining the water received in the sump; and
a filter provided to the sump, the filter comprises:
a contaminant collection chamber for filtering the washing water;
a sampling passage for guiding a portion of the water pumped by the washing pump to the contaminant collection chamber; and
a contamination level sensor for measuring a contamination level of the washing water on the sampling passage.

11. The dishwasher of claim 10, wherein the contamination level sensor comprises an optical sensor having a light-receiving unit and a light-emitting unit.

12. The dishwasher of claim 11, wherein the optical sensor has an exterior formed by cutting a cylinder vertically into halves and leaving a prescribed distance between the halves that are the light-receiving and light-emitting units, respectively.

13. The dishwasher of claim 10, the filter comprises:
a lower housing having a contaminant collection chamber;
an upper housing having the sampling passage; and
a cover covering a topside of the sump, the cover comprising:
a filter screen located above the contaminant collection chamber; and
a recovery hole on a periphery of the sump to receive the washing water.

14. The dishwasher of claim 13, wherein the contamination collection chamber and the sampling passage communicate through a coupling portion of the lower housing and a perforated hole formed at an end of the sampling passage of the upper housing.

15. The dishwasher of claim 14, wherein the coupling portion is connected to the perforated hole to provide a first passage for the washing water to flow, and the coupling portion is further provided with a second passage for the washing water to overflow to the contamination collection chamber.

16. The dishwasher of claim 15, wherein the first passage of the coupling portion comprises an inner duct which has a smaller circumference than that of the coupling portion to permit the washing water to overflow via the second passage which is a passage between an outer surface area of the inner duct and an inner surface area of the coupling portion.

17. The dishwasher of claim 13, wherein the coupling portion communicates with the drain chamber as well as the contaminant collection chamber.

18. A method of controlling a dishwasher, comprising:
starting a washing pump;
detecting a contamination level of washing water;
correcting a washing time previously set in a control unit based on the detected contamination level; and
operating the washing pump according to the corrected washing time.

19. The method of claim 18, wherein the contamination level of the water is detected if a predetermined time expires after starting the washing pump.

20. A method of controlling a dishwasher, comprising:
starting a washing pump;
detecting a contamination level of washing water;
draining a portion of the washing water by driving a drain pump if the detected contamination level exceeds a contamination level previously set by a control unit; and
adding a specified amount of new water in proportion to the drained amount to the washing water.

21. The method of claim 20, wherein the contamination level of the water is detected if a predetermined time expires after starting the washing pump.

22. The method of claim 20, wherein the washing pump is stopped in draining the water or in adding the new water.

23. The method of claim 20, wherein a drain quantity of the water is adjusted according to the detected contamination level.

24. The method of claim 20, further comprising:
re-detecting the contamination level of the washing water after the new water added;
correcting the washing time previously set by the control unit based on to the re-detected contamination level; and
operating the washing pump according to the corrected washing time.

25. The method of claim 24, wherein the contamination level of the water having the new water added is re-detected if a predetermined time expires after adding the new water.
